(19) United States
(12) Patent Application Publication
(10) Pub. No.: US 2025/0382396 A1
(43) Pub. Date: Dec. 18, 2025

(54) COMPOSITION COMPRISING VINYL ALCOHOL POLYMER, METHOD FOR PRODUCING SAME, VINYL ALCOHOL POLYMER AND RESIN MATERIAL

(71) Applicant: KURARAY CO., LTD., Okayama (JP)

(72) Inventors: Yuji OKAMOTO, Bangkok (TH); Taeko KAHARU, Chiba (JP); Masaki KATO, Houston, TX (US)

(73) Assignee: KURARAY CO., LTD., Okayama (JP)

(21) Appl. No.: 18/878,594

(22) PCT Filed: Jun. 20, 2023
(86) PCT No.: PCT/JP2023/022766

§ 371 Date: Dec. 23, 2024

(30) Foreign Application Priority Data
Jun. 22, 2022 (JP) 2022-099995

(51) Int. Cl. C08F 8/12; C08F 218/08

(52) U.S. Cl. CPC C08F 8/12; C08F 218/08

(57) ABSTRACT

The present invention relates to a composition (provided that a composition for household detergent products is excluded) comprising:
(A) a vinyl alcohol-based polymer containing a monomer unit having an alkyl group;
(B) at least one surfactant; and
(C) water,
wherein the vinyl alcohol-based polymer (A) satisfies the following formula (1):

$$0.01 \leq X / ( S \times N ) \leq 0.040 \qquad ( 1 )$$

wherein S represents the content (parts by mass) of the monomer unit having an alkyl group based on 100 parts by mass of the total monomer unit in the vinyl alcohol-based polymer (A), X represents the degree (% by mol) of saponification of the vinyl alcohol-based polymer (A), and N represents the viscosity-average degree of polymerization of the vinyl alcohol-based polymer (A).

### TECHNICAL FIELD

The present invention relates to a composition comprising a vinyl alcohol-based polymer (provided that a composition for household detergent products is excluded), and a method for producing the composition. The present invention also relates to a vinyl alcohol-based polymer which the composition contains, and a resin material comprising the vinyl alcohol-based polymer.

### BACKGROUND ART

Conventionally, vinyl alcohol-based polymers have been used in wide applications such as adhesives, processing agents for paper products and fiber products, paint, various binders, and the like. It is known for a composition including a vinyl alcohol-based polymer depending on various applications that, when the vinyl alcohol- based polymer is hydrophobic, an appropriate surfactant is used for dissolving this hydrophobic vinyl alcohol-based polymer in water (Patent Document 1).

### PRIOR ART DOCUMENTS

### Patent Documents

Patent Document 1: JP-A S53-133252

### SUMMARY OF THE INVENTION

### Problems to be Solved by the Invention

As described in the Patent Document and the like, an aqueous solution of a hydrophobic vinyl alcohol-based polymer can be obtained by adding an appropriate surfactant to water. However, a composition (aqueous solution) in which a hydrophobic vinyl alcohol-based polymer is dissolved in water comprising a surfactant is hardly controlled in viscosity, and tends to hardly achieve particularly the thickening effect. Therefore, a possible problem is that a large amount of a vinyl alcohol-based polymer needs to be added in order to obtain a composition having a relatively high viscosity, and, in this case, the degree of transparency of the composition is reduced.

An object of the present invention is to provide a composition (aqueous solution) comprising a hydrophobic vinyl alcohol-based polymer, the composition being not only high in viscosity, but also excellent in transparency, and a method for producing the composition. Another object of the present invention is to provide a vinyl alcohol- based polymer capable of providing the above composition (aqueous solution), and a resin material comprising the vinyl alcohol-based polymer.

### Solutions to the Problems

The present inventors intensively studied to solve the above-described problems, thereby completing the present invention. Specifically, the present invention encompasses the following aspects.
[1] A composition (provided that a composition for household detergent products is excluded) comprising:
   (A) a vinyl alcohol-based polymer comprising a monomer unit having an alkyl group:
   (B) at least one surfactant: and
   (C) water, wherein the vinyl alcohol-based polymer (A) satisfies the following formula (1):

$$0.01 \leq X / ( S \times N ) \leq 0.040 \qquad ( 1 )$$

wherein S represents the content (parts by mass) of the monomer unit having an alkyl group based on 100 parts by mass of the total monomer unit in the vinyl alcohol-based polymer (A), X represents the degree (% by mol) of saponification of the vinyl alcohol-based polymer (A), and N represents the viscosity-average degree of polymerization of the vinyl alcohol-based polymer (A).
[2] The composition according to [1], wherein the vinyl alcohol-based polymer (A) comprises a monomer unit having an alkyl group having 4 to 16 carbon atoms.
[3] The composition according to [1] or [2], wherein the monomer unit having an alkyl group comprises an a-olefin-derived monomer unit.
[4] The composition according to any one of [1] to [3], wherein the monomer unit having an alkyl group comprises an a-olefin-derived monomer unit, and the content of the α-olefin-derived monomer unit having an alkyl group based on the total amount of the monomer unit having an alkyl group is 60% by mass or more.
[5] The composition according to any one of [1] to [4], wherein the content S of the monomer unit having an alkyl group based on 100 parts by mass of the total monomer unit in the vinyl alcohol-based polymer (A) is 1.2 to 9.0 parts by mass.
[6] The composition according to any one of [1] to [5], wherein the degree X of saponification of the vinyl alcohol-based polymer (A) is 40 to 80% by mol.

[7] The composition according to any one of [1] to [6], wherein the viscosity-average degree N of polymerization of the vinyl alcohol-based polymer (A) is 400 to 2000.
[8] The composition according to any one of [1] to [7], wherein the mass ratio (A/B) between the vinyl alcohol-based polymer (A) and the surfactant (B) is 1/99 to 99/1.
[9] The composition according to any one of [1] to [8], wherein the surfactant (B) comprises an anionic surfactant.
[10] The composition according to any one of [1] to [9], wherein the surfactant (B) contains at least one selected from the group consisting of alkyl sulfate, alkyl sulfonate, alkylbenzene sulfonate, polyoxyalkylene alkyl ether sulfate (alkyl ether sulfate), polyoxyalkylene alkyl ether carboxylate (alkyl ether acetate), α-olefin sulfonate, a phosphoric ester salt, an acylamino acid salt, acyl taurate, acyl lactate, soap (higher fatty acid), alkyl sulfosuccinate, an acyl hydrolyzed collagen salt and acyl isethionate.
[11] The composition according to any one of [1] to [10], wherein the content of the vinyl alcohol-based polymer (A) is 0.1 to 5.0% by mass based on the total mass of the composition.
[12] The composition according to any one of [1] to [11], wherein the content of the surfactant (B) is 1 to 50% by mass based on the total mass of the composition.
[13] The composition according to any one of [1] to [12], wherein the relative viscosity of the composition, as calculated according to the following, is 1.60 to 3.10:
   Relative viscosity of composition =Viscosity at 2020 C. of composition/Viscosity at 20°° C. of viscosity-reference composition having formulation excluding vinyl alcohol-based polymer (A) from composition as measurement object.
[14] The composition according to any one of [1] to [13], wherein the viscosity at 20° C. is 1,300 to 3,000 mPa·s.
[15] A composition comprising:
   (A) a vinyl alcohol-based polymer comprising a monomer unit having an alkyl group:
   (B) a surfactant: and
   (C) water,
   wherein the vinyl alcohol-based polymer (A) satisfies the following formula (1):

$$0.01 \leq X / ( S \times N ) \leq 0.040 \qquad ( 1 )$$

wherein S represents the content (parts by mass) of the monomer unit having an alkyl group based on 100 parts by mass of the total monomer unit in the vinyl alcohol-based polymer (A), X represents the degree (% by mol) of saponification of the vinyl alcohol-based polymer (A), and N represents the viscosity-average degree of polymerization of the vinyl alcohol-based polymer (A), and
wherein the composition is a composition selected from the group consisting of a composition for agricultural products, a composition for automobile products, a composition for aviation products, a composition for industrial products, a composition for livestock products, a marine product composition, a pharmaceutical composition, a composition for personal care products, a composition for recreation products, and a water treatment agent composition.
[16] The composition according to [15], wherein the monomer unit having an alkyl group comprises an α-olefin-derived monomer unit, and the content of the α-olefin-derived monomer unit having an alkyl group based on the total amount of the monomer unit having an alkyl group is 60% by mass or more.
[17] A method for producing the composition according to any one of [1] to [16], the method comprising adding the vinyl alcohol-based polymer (A) in a solid state, to a solution comprising the surfactant (B) and water.
[18] A vinyl alcohol-based polymer (A) comprising a monomer unit having an alkyl group,
   wherein the vinyl alcohol-based polymer (A) satisfies the following formula (1):

$$0.01 \leq X / ( S \times N ) \leq 0.040 \qquad ( 1 )$$

wherein S is the content (parts by mass) of the monomer unit having an alkyl group based on 100 parts by mass of the total monomer unit in the vinyl alcohol-based polymer (A), X is the degree (% by mol) of saponification of the vinyl alcohol-based polymer (A), and N is the viscosity-average degree of polymerization of the vinyl alcohol-based polymer (A).
[19] The vinyl alcohol-based polymer (A) according to [18], wherein
   the monomer unit having an alkyl group comprises an α-olefin-derived monomer unit, and
   the content of the a-olefin-derived monomer unit having an alkyl group based on the total amount of the monomer unit having an alkyl group is 60% by mass or more.
[20] A resin material comprising the vinyl alcohol-based polymer (A) according to [18] or [19], wherein
   the resin material comprises an α-olefin and sodium acetate, and
   the content of the α-olefin is 0.05% by mass or more, and the content of the sodium acetate is 2.0% by mass or less, based on the total mass of the resin material.
[21] The resin material according to [20], wherein the α-olefin comprises an a-olefin having 6 to 18 carbon atoms.
[22] The resin material according to or [21], wherein the a-olefin comprises at least one selected from the group consisting of 1-dodecene and 1-hexadecene.

### EFFECTS OF THE INVENTION

According to the present invention, it is possible to provide a composition comprising a hydrophobic vinyl alcohol-based polymer (aqueous solution), the composition being not only high in viscosity, but also excellent in transparency, and a method for producing the composition. The present invention can also provide a vinyl alcohol-based polymer capable of providing the composition (aqueous solution), and a resin material comprising the vinyl alcohol-based polymer.

### DETAILED DESCRIPTION

Hereinafter, embodiments of the present invention are described in detail. It is noted that the scope of the present invention is not limited by embodiments herein described and various modification can be made as long as the gist of the present invention is not impaired.

### Vinyl Alcohol-Based Polymer (A)

The composition of the present invention contains (A) a vinyl alcohol-based polymer comprising a monomer unit having an alkyl group, and the vinyl alcohol-based polymer (A) satisfies the following formula (1) (hereinafter, also referred to as “vinyl alcohol-based polymer (A)”).

$$0.01 \leq X / ( S \times N ) \leq 0.040 \qquad ( 1 )$$

In the formula (1), S is the content (parts by mass) of the monomer unit having an alkyl group based on 100 parts by mass of the total monomer unit in the vinyl alcohol-based polymer (A), X is the degree (% by mol) of saponification of the vinyl alcohol-based polymer (A), and N is the viscosity-average degree of polymerization of the vinyl alcohol-based polymer (A).

The formula (1) can serve as a new index representing the balance between the solubility in water and the thickening effect, of the vinyl alcohol-based polymer (A). If the content(S) of the monomer unit having an alkyl group in the total monomer unit constituting the vinyl alcohol-based polymer (A) is higher and/or the viscosity-average degree (N) of polymerization of the vinyl alcohol-based polymer is higher in the formula (1), there is a tendency that the solubility of the vinyl alcohol-based polymer is lower and the viscosity of a composition comprising the vinyl alcohol-based polymer is higher. On the other hand, if the degree (X) of saponification of the vinyl alcohol-based polymer (A) is higher, there is a tendency that the solubility of the vinyl alcohol-based polymer in the composition is higher. Accordingly, a composition not only having a high viscosity, but also being excellent in solubility in water and high in transparency can be obtained by controlling the value of the formula (1) with adjustment of the degree (X) of saponification, the content(S) of the monomer unit having an alkyl group and/or the viscosity-average degree (N) of polymerization with respect to of the vinyl alcohol-based polymer (A). As mentioned herein, the “thickening effect” means the effect of increasing the viscosity of an objective composition comprising a vinyl alcohol-based polymer, as compared with the viscosity of a different composition from this composition only in that such a vinyl alcohol-based polymer is removed.

In general, as the value of the formula (1) is smaller, the thickening effect is higher (namely, a high-viscosity composition can be obtained). On the other hand, if the value of the formula (1) is too small, the thickening effect can be expected, but a high transparency can be made difficult to ensure. The lower limit of the formula (1) in the composition of the present invention is 0.010 or more. When the value of the formula (1) is 0.010 or more, a composition which not only ensures a high viscosity, but also is excellent in transparency can be obtained.

As the value of the formula (1) is larger, the solubility of the vinyl alcohol-based polymer (A) in an aqueous solution is usually higher (namely, a composition high in transparency can be obtained). On the other hand, if the value of the formula (1) is too large, the solubility can be enhanced, but the viscosity tends to be lower. The upper limit of the formula (1) in the composition of the present invention is 0.040 or less. When the value of the formula (1) is 0.040 or less, a composition which not only ensures the thickening effect, but also has a high transparency can be obtained.

The value of the formula (1) in the present invention is 0.010 or more and 0.040 or less. When the value of the formula (1) is in the above range, a composition high in viscosity and excellent in transparency can be prepared. In one embodiment of the present invention, the value of the formula (1) is preferably 0.010 to 0.038, more preferably 0.010 to 0.035, further preferably 0.010 to 0.030, particularly preferably 0.010 to 0.025, especially preferably 0.010 to 0.024, and preferably 0.012 to 0.040, and may be, for example, 0.013 to 0.040. When the value of the formula (1) is within the range between the lower limit and the upper limit, not only a composition higher in viscosity and more excellent in transparency is obtained, but also the transparency of the composition is easily inhibited from being reduced over time.

In calculation of the value of the formula (1), the degree (X) (% by mol) of saponification and the viscosity-average degree (N) of polymerization of the vinyl alcohol-based polymer (A) can be each measured based on JIS K 6726 “Testing methods for polyvinyl alcohol”. More specifically, such measurement can be made by a method described in Examples below.

The value of the formula (1) can be controlled by adjusting the content (parts by mass) of the monomer unit having an alkyl group in the total monomer unit constituting the vinyl alcohol-based polymer (A), the degree of saponification of the vinyl alcohol-based polymer (A), and/or the viscosity-average degree of polymerization of the vinyl alcohol-based polymer (A).

The vinyl alcohol-based polymer (A) satisfying the formula (1) can be prepared by, for example, copolymerizing a vinyl ester monomer and a monomer having an alkyl group (hereinafter, also referred to as “alkyl group-containing monomer”), and saponifying the resulting vinyl ester-based copolymer.

Examples of the vinyl ester monomer used for formation of the vinyl alcohol-based polymer (A) include vinyl formate, vinyl acetate, vinyl propionate, vinyl valerate, vinyl caprate, vinyl laurate, vinyl stearate, vinyl benzoate, vinyl butyrate, vinyl isobutyrate, vinyl pivalate, vinyl versatate, vinyl caproate, vinyl caprylate, vinyl caprate, vinyl laurate, vinyl palmitate, vinyl stearate, and vinyl oleate. In particular, vinyl acetate is preferred because of being easily available and high in economic performance. The vinyl ester monomer may be used singly, or in combination of two or more kinds thereof.

The content of the vinyl ester monomer-derived structural unit in the vinyl alcohol-based polymer (A) is preferably 82 to 97 parts by mass, more preferably 86 to 97 parts by mass based on 100 parts by mass of the total monomer unit constituting the vinyl alcohol-based polymer (A).

Herein, the “vinyl ester monomer-derived structural unit” refers to a structural unit derived from the vinyl ester monomer as a raw material in the vinyl alcohol-based polymer (A), and the “vinyl ester monomer-derived structural unit” includes a vinyl ester unit, and a vinyl alcohol unit in which the vinyl ester unit is converted by saponification.

The content of the vinyl ester monomer-derived structural unit in the vinyl alcohol-based polymer (A) can be determined by calculating the proportion (% by mol) of the vinyl ester monomer-derived structural unit relative to the entire constituent unit of the polyvinyl alcohol-based polymer (A) by ¹H NMR, and converting the calculated proportion into the proportion (parts by mass) from the molecular weight of each constituent unit.

Any alkyl group-containing monomer can be used as long as it is a monomer copolymerizable with the vinyl ester monomer and containing an alkyl group in its structure. Examples include α-olefins such as propylene, 1-butene, isobutene, pentene, 1-hexene, 1-octene, 1-dodecene, 1-hexadecene and 1-octadecene, methacrylic acid: (meth)acrylates such as methyl (meth)acrylate, ethyl (meth)acrylate, n-propyl (meth)acrylate, isopropyl (meth)acrylate, n-butyl (meth)acrylate, 2-ethylhexyl (meth)acrylate, cyclohexyl (meth)acrylate, stearyl (meth)acrylate and octadecyl (meth)acrylate: acrylamide derivatives such as N-methyl acrylamide and N-ethyl acrylamide: methacrylamide derivatives such as N-methyl methacrylamide and N-ethyl methacrylamide: vinyl ethers such as methyl vinyl ether, ethyl vinyl ether, n-propyl vinyl ether, isopropyl vinyl ether, n-butyl vinyl ether, lauryl vinyl ether and stearyl vinyl ether, allyl acetate: allyl ethers such as propyl allyl ether, butyl allyl ether and hexyl allyl ether: monomers each having an oxyalkelene group: isopropenyl acetate: and monomers each having a silyl group, such as vinylmethyldimethoxysilane, vinyldimethylmethoxysilane, vinyltriethoxysilane, vinylmethyldiethoxysilane, vinyldimethylethoxysilane, 3-(meth)acrylamide propyltrimethoxysilane and 3-(meth)acrylamide propyltriethoxysilane. The alkyl group-containing monomer may be used singly, or in combination of two or more thereof.

The “monomer unit having an alkyl group (hereinafter, also referred to as alkyl group-containing monomer unit)” in the present invention means an alkyl group-containing monomer-derived structural unit in the vinyl alcohol-based polymer (A). The vinyl alcohol-based polymer (A) preferably contains an alkyl group-containing monomer unit having 4 to 16 carbon atoms. The number of carbon atoms in the alkyl group in the alkyl group-containing monomer unit is preferably 4 to 16, more preferably 6 to 16, further preferably 8 to 16, particularly preferably 10 to 16, and preferably 4 to 14. When the number of carbon atoms in the alkyl group in the alkyl group-containing monomer unit is within the range between the lower limit and the upper limit, the degree of polymerization is higher, and not only the thickening effect is ensured, but also solubility is easily controlled. Herein, the number of carbon atoms in the alkyl group in the alkyl group-containing monomer unit means the number of carbon atoms in a side chain of the vinyl alcohol-based polymer (A) in the above unit. For example, the number of carbon atoms in the alkyl group in a 1-dodecene-derived monomer unit in a vinyl alcohol-based polymer obtained by copolymerization and saponification of vinyl acetate and 1-dodecene (number of carbon atoms 12) as the alkyl group-containing monomer is 10.

The alkyl group-containing monomer unit in the vinyl alcohol-based polymer (A) is preferably an α-olefin-derived monomer unit. In one embodiment of the present invention, the content of the α-olefin-derived monomer unit relative to the total alkyl group-containing monomer unit constituting the vinyl alcohol-based polymer (A) is preferably 60 to 100% by mass, more preferably 70 to 100% by mass, further preferably 80 to 100% by mass, particularly preferably 90 to 100% by mass. When the α-olefin-derived monomer unit is contained as the alkyl group-containing monomer unit in the above range, the thickening effect and solubility can be more enhanced. Examples of the α-olefin capable of introducing the α-olefin-derived monomer unit into the vinyl alcohol-based polymer (A) include α-olefins exemplified above with respect to the alkyl group-containing monomer. In particular, the α-olefin-derived monomer unit preferably having 6 to 18 carbon atoms, more preferably 8 to 18 carbon atoms, further preferably 8 to 16 carbon atoms, such as 1-hexene, 1-heptene, 1-octene, 1-nonene, 1-decene, 1-dodecene, 1-tridecene, 1-tetradecene, 1-pentadecene, 1-hexadecene, or 1-octadecene is used from the viewpoint of easily providing a predetermined thickening effect and easily controlling solubility.

The content of the alkyl group-containing monomer unit in the vinyl alcohol-based polymer (A) is preferably 1.2 to 9.0 parts by mass based on 100 parts by mass of the total monomer unit constituting the vinyl alcohol-based polymer (A). When the content of the alkyl group-containing monomer unit is equal to or more than the lower limit, the degree of polymerization is easily enhanced and a high viscosity is easily ensured. When the content is equal to or less than the upper limit, the solubility in water comprising a surfactant is easily ensured. The content of the alkyl group-containing monomer unit can be appropriately determined depending on desired viscosity and solubility, and, in one embodiment of the present invention, is preferably 1.5 to 9.0 parts by mass, more preferably 2.0 to 9.0 parts by mass, further preferably 2.5 to 9.0 parts by mass, particularly preferably 2.8 to 9.0 parts by mass, and preferably 1.2 to 8.5 parts by mass, more preferably 1.2 to 8.0 parts by mass, further preferably 1.2 to 7.5 parts by mass, particularly preferably 1.2 to 7.0 parts by mass based on 100 parts by mass of the entire monomer unit.

The content of the alkyl group-containing monomer unit in the vinyl alcohol-based polymer (A) can be determined by calculating the proportion (% by mol) of the alkyl group-containing monomer unit relative to the entire constituent unit of the polyvinyl alcohol-based polymer (A) by ¹H NMR, and converting the calculated proportion into the proportion (parts by mass) from the molecular weight of each constituent unit.

In the present invention, the content of the alkyl group-containing monomer unit in the vinyl alcohol-based polymer (A) is controlled by “parts by mass” based on 100 parts by mass of the total monomer unit constituting the vinyl alcohol-based polymer (A). In general, the proportion of a monomer constituting a polymer is often controlled by “% by mol”. However, the length of the alkyl group of such a monomer can also have a large effect on the solubility and the thickening effect. Therefore, in the present invention, the amount of the alkyl group-containing monomer unit is controlled in terms of “parts by mass” easily reflecting also the length of the alkyl group, and thus the value of the formula (1) is utilized as an index for the solubility and the thickening effect.

In the present invention, the vinyl alcohol-based polymer (A) has the alkyl group-containing monomer unit, and usually exhibits hydrophobicity.

The degree (X) of saponification of the vinyl alcohol-based polymer (A) is preferably 40 to 80% by mol. When the degree (X) of saponification is within the above range, the solubility of the vinyl alcohol-based polymer (A) in water comprising a surfactant is easily enhanced, and a composition having high transparency is easily obtained. In one embodiment of the present invention, the degree (X) of saponification is preferably 40 to 75% by mol, more preferably 40 to 70% by mol, further preferably 40 to 65% by mol, particularly preferably 40 to 60% by mol (or less than 60% by mol), especially preferably 40 to 50% by mol (or less than 50% by mol). When the degree (X) of saponification is within the range between the lower limit and the upper limit, not only the solubility and the transparency are more excellent, but also the transparency of the composition is easily inhibited from being reduced over time. In a case where the vinyl alcohol-based polymer (A), which has a relatively low degree of saponification as in the above range, is contained, a higher thickening effect is easily obtained.

The viscosity-average degree (N) of polymerization of the vinyl alcohol-based polymer (A) is preferably 400 to 2000. When the viscosity-average degree (N) of polymerization is equal to or more than the lower limit, a higher thickening effect can be expected, and when the viscosity-average degree is equal to or less than the upper limit, excess thickening is avoided, and a required solubility is easily ensured. In one embodiment of the present invention, the viscosity-average degree (N) of polymerization is more preferably 450 to 2000, further preferably 450 to 1800, particularly preferably 450 to 1700.

The vinyl alcohol-based polymer (A) may have a structural unit (hereinafter, also referred to as “other structural unit”) other than the vinyl ester monomer-derived structural unit and the alkyl group-containing monomer-derived structural unit, as long as the effects of the present invention are not affected. Examples of a monomer into which such other structural unit can be introduced include acrylic acid: hydroxy group-containing vinyl ethers such as ethylene glycol vinyl ether, 1,3-propanediol vinyl ether and 1,4-butanediolvinyl ether: hydroxy group-containing a-olefins such as 3-buten-1-ol, 4-penten-1-ol, 5-hexen-1-ol, 7-octen-1-ol, 9-decen-1-ol and 3-methyl-3-buten-1-ol: and vinyltrimethoxysilane. The monomer into which such other structural unit can be introduced may be used singly, or in combination of two or more thereof.

In a case where the vinyl alcohol-based polymer (A) has such other structural unit, the content of such other structural unit is usually 9.0 parts by mass or less, and preferably 8.0 parts by mass or less, more preferably 7.0 parts by mass or less, based on 100 parts by mass of the total monomer unit constituting the vinyl alcohol-based polymer (A)

The vinyl alcohol-based polymer (A) can be produced according to a conventionally known method. For example, a bulk polymerization method, a solution polymerization method, a suspension polymerization method, an emulsion polymerization method, or a dispersion polymerization method can be adopted as the method for obtaining a vinyl ester-based copolymer from the vinyl ester monomer and the alkyl group-containing monomer. In particular, a solution polymerization method is industrially preferred.

A polymerization initiator may be used in preparation of the vinyl ester-based copolymer. The polymerization initiator may be selected from a known initiator depending on the polymerization method. Specific examples include azo-based initiators such as 2,2′-azobisisobutyronitrile, 2,2′-azobis(2,4-dimethylvaleronitrile) and 2,2′-azobis(4-methoxy-2,4-dimethylvaleronitrile), and, peroxide-based initiators, for example, percarbonate compounds such as diisopropyl peroxydicarbonate, di-2-ethylhexyl peroxydicarbonate and diethoxyethyl peroxydicarbonate: perester compounds such as t-butyl peroxyneodecanate, α-cumyl peroxyneodecanate and t-butyl peroxydecanate: acetylcyclohexylsulfonyl peroxide: and 2,4,4-trimethylpentyl-2-peroxyphenoxyacetate.

The amount of the polymerization initiator may be appropriately determined depending on the types of the monomer and initiator used, the objective degree of polymerization, and the like, and is preferably 0.20 to 0.33% by mass based on the total mass of the vinyl ester monomer.

Polymerization conditions may be appropriately determined depending on the type and amount of the monomer used, desired physical properties, the polymerization method adopted. For example, the polymerization temperature is usually 0 to 150° C., preferably 20 to 120° C.

The rate of polymerization in the vinyl ester-based copolymer may be, for example, 20 to 95%. The rate of polymerization is preferably 30% or more, more preferably 40% or more from the viewpoint of an enhancement in yield and control of the degree of polymerization.

In a saponification reaction of the resulting vinyl ester-based copolymer, alcoholysis or hydrolysis reaction can be applied in which a conventionally known basic catalyst such as sodium hydroxide, potassium hydroxide or sodium methoxide, or an acidic catalyst such as p-toluenesulfonic acid is used. Examples of the solvent used in the saponification reaction include alcohols such as methanol and ethanol: esters such as methyl acetate and ethyl acetate: ketones such as acetone and methyl ethyl ketone: and aromatic hydrocarbons such as benzene and toluene. These may be used singly, or in combination of two or more thereof. In particular, the saponification reaction is preferably a method in which such a saponification reaction is conducted in the presence of sodium hydroxide as a basic catalyst with, as the solvent, methanol or a mixed solution of methanol and methyl acetate.

The amount of the catalyst used in the saponification reaction may be appropriately determined depending on the type of the catalyst used, the objective degree of saponification. For example, in a case where sodium hydroxide is used as the catalyst of the saponification reaction, in one aspect of the present invention, the proportion (molar ratio) of the catalyst to the vinyl ester monomer in the vinyl ester-based copolymer is preferably 0.0035 to 0.0095.

The content of the vinyl alcohol-based polymer (A) in the composition of the present invention can be appropriately determined depending on the structure (type) of the vinyl alcohol-based polymer (A), the application of the composition, the desired viscosity. In one embodiment of the present invention, the content of the vinyl alcohol-based polymer (A) is preferably 0.1 to 5.0% by mass, more preferably 0.5 to 5.0% by mass, further preferably 0.5 to 4.0% by mass based on the total mass of the composition. In a case where two or more of vinyl alcohol-based polymers (A) are included in the composition of the present invention, the total thereof is preferably within the above range.

The composition of the present invention may include a vinyl alcohol-based polymer other than the vinyl alcohol-based polymer (A). In a case where other vinyl alcohol-based polymer than the vinyl alcohol-based polymer (A) is included, the proportion of the vinyl alcohol-based polymer (A) based on the total mass of the vinyl alcohol-based polymer included in the composition is preferably 80% by mass or more, more preferably 90% by mass or more.

### Surfactant (B)

The composition of the present invention includes (B) at least one surfactant. The surfactant in the composition of the present invention is not limited as long as it can contribute to dissolution of the vinyl alcohol-based polymer (A) in water, and any of an anionic surfactant, a cationic surfactant, a non-ionic surfactant, and a zwitterionic surfactant may be adopted as long as such a role can be filled. In particular, the composition of the present invention preferably contains at least one anionic surfactant as the surfactant from the viewpoint of easily ensuring the solubility of the vinyl alcohol-based polymer (A) in water.

The surfactant used in the present invention, particularly, the anionic surfactant is preferably, for example, at least one selected from the group consisting of alkyl sulfate, alkyl sulfonate, alkylbenzene sulfonate, polyoxyalkylene alkyl ether sulfate (alkyl ether sulfate), polyoxyalkylene alkyl ether carboxylate (alkyl ether acetate), α-olefin sulfonate, a phosphoric ester salt, an acylamino acid salt, acyl taurate, acyl lactate, soap (higher fatty acid), alkyl sulfosuccinate, an acyl hydrolyzed collagen salt and acyl isethionate. In particular, at least one selected from the group consisting of alkyl sulfate, alkyl sulfonate, alkylbenzene sulfonate, polyoxyalkylene alkyl ether sulfate (alkyl ether sulfate), polyoxyalkylene alkyl ether carboxylate (alkyl ether acetate), and α-olefin sulfonate is preferred, and at least one selected from the group consisting of alkyl sulfate and polyoxyalkylene alkyl ether sulfate (alkyl ether sulfate) is more preferred, because of being excellent in function of allowing the vinyl alcohol-based polymer (A) to be soluble in water.

The “salt” in the anionic surfactant, exemplified herein, is, for example, an alkali metal salt (e.g., lithium salt, sodium salt, potassium salt), an alkali earth metal salt (e.g., magnesium salt, calcium salt), an ammonium salt, or an amine salt (e.g., monoethanolamine salt, diethanolamine salt, triethanolamine salt).

The alkyl sulfate is preferably, for example, an alkyl sulfate having 6 to 18 carbon atoms, and specific examples thereof include sodium lauryl sulfate, ammonium lauryl sulfate, sodium hexyl sulfate, sodium heptyl sulfate, sodium octyl sulfate, sodium decyl sulfate, sodium tridecyl sulfate, sodium tetradecyl sulfate, sodium pentadecyl sulfate, sodium hexadecyl sulfate, and sodium octadecyl sulfate.

Examples of the alkyl sulfonate include an alkyl sulfonate having 6 to 18 carbon atoms.

The alkylbenzene sulfonate is preferably, for example, an alkylbenzene sulfonate having 6 to 18 carbon atoms, and specific examples thereof include sodium lauryl benzene sulfonate.

Examples of the polyoxyalkylene alkyl ether sulfate (alkyl ether sulfate) include sodium laureth sulfate and ammonium laureth sulfate.

Examples of the polyoxyalkylene alkyl ether carboxylate (alkyl ether acetate) include polyoxyethylene lauryl ether sodium acetate and polyoxyethylene stearyl ether sodium acetate.

Examples of the a-olefin sulfonate include sodium a-olefin sulfonate having 6 to 18 carbon atoms.

Examples of the phosphoric ester salt include a sodium salt of monolauryl phosphoric acid.

Examples of the acylamino acid salt include N-acylglutamates such as sodium cocoyl glutamate. Examples of the acyl taulate include sodium cocoyl methyltaurinate.

Examples of the acyl lactate include sodium stearoyl lactylate and sodium isostearoyl lactylate.

Examples of the soap (higher fatty acid) include sodium laurate, potassium laurate, sodium palmitate, potassium palmitate, potassium myristate, and potassium stearate.

Examples of the alkyl sulfosuccinate include disodium lauryl sulfosuccinate.

Examples of the acyl isethionate include lauroyl isethionate.

The content of the surfactant (B) in the composition of the present invention can be appropriately determined depending on the type of the surfactant, the intended application of the composition, the desired viscosity. In one embodiment of the present invention, the content of the surfactant (B) is preferably 1 to 50% by mass, more preferably 5 to 50% by mass, further preferably 5 to 40% by mass based on the total mass of the composition. In a case where a plurality of such surfactants is included in the composition of the present invention, the amount of the anionic surfactant (total amount in a case where two or more of anionic surfactants are included) is preferably within the above range. In particular, the amount of the anionic surfactant is preferably 5 to 50% by mass, more preferably 10 to 50% by mass, further preferably 15 to 50% by mass based on the total mass of the composition. In a case where the anionic surfactant and other surfactant are included, preferably, the amount of the anionic surfactant is within the above range and the amount of such other surfactant is smaller than the amount of the anionic surfactant, and the content of such other surfactant than the anionic surfactant is more preferably 30 parts by mass or less, further preferably 10 parts by mass or less, based on 100 parts by mass of the content of the anionic surfactant.

In one aspect of the present invention, the mass ratio (A/B) between the vinyl alcohol-based polymer (A) and the surfactant (B) in the composition of the present invention is preferably 1/99 to 99/1 (0.01 to 99.00), more preferably 1/99 to 80/20 (0.01 to 4.00), further preferably 1/99 to 50/50 (0.01 to 1.00), particularly preferably 5/95 to 40/60 (0.05 to 0.67). When the mass ratio between the vinyl alcohol-based polymer (A) and the surfactant (B) is within the above range, the solubility of the vinyl alcohol-based polymer (A) in water is easily enhanced. Thus, a composition can be obtained which not only ensures the thickening effect by the vinyl alcohol-based polymer (A), but also is excellent in transparency. In a case where the composition of the present invention includes a plurality of such surfactants, the amount of the anionic surfactant (total amount in a case where two or more of such anionic surfactants are included) and the amount of the vinyl alcohol-based polymer (A) are preferably in the above relationship.

The composition of the present invention contains (C) water, and is an aqueous solution of the vinyl alcohol-based polymer (A). The content of the water in the composition of the present invention is not particularly limited, and can be appropriately determined depending on the application of the composition, the desired viscosity. In one embodiment of the present invention, the amount of the water in the composition of the present invention is preferably 30 to 90% by mass, more preferably 40 to 90% by mass, further preferably 40 to 80% by mass based on the total mass of the composition.

The composition of the present invention may include an additional component, in addition to the vinyl alcohol-based polymer (A), the surfactant (B) and water, depending on the intended application of the composition, as long as the effects of the present invention are not affected. Examples of the component include a pH adjuster, an antioxidant, an ultraviolet absorber, a water-soluble or hydrophilic organic solvent, a preservative agent, an antimicrobial agent, a fungicide, a colorant, a chelating agent, a dispersant, and an antistatic agent.

In the composition of the present invention, the relative viscosity of the composition, as calculated according to the following, is preferably 1.60 to 3.10:
(Relative viscosity of composition) = (Viscosity at 20°° C. of composition)/(Viscosity at 20°° C. of viscosity-reference composition having formulation excluding vinyl alcohol-based polymer (A) from composition as measurement object)

Herein, the “viscosity at 20°° C. of the composition” is the viscosity at 20° C. of a composition serving as an object for calculation of the relative viscosity. The “viscosity-reference composition” means a composition having a formulation which is different from that of the composition serving as an object for calculation of the relative viscosity only in that the vinyl alcohol-based polymer (A) is not compounded.

When the relative viscosity of the composition, as calculated according to the above, is within the above range, a sufficient thickening effect by the vinyl alcohol-based polymer (A) can be expected. The relative viscosity of the composition, as calculated according to the above, is more preferably 1.65 to 3.10, further preferably 1.70 to 3.10 from the viewpoint of imparting a higher thickening effect.

The viscosity of each of the composition and the viscosity-reference composition can be measured at 20° C. with, for example, a B-type viscometer (spindles LV-03 and LV-04, number of rotations 60 rpm).

The viscosity at 20°° C. of the composition of the present invention is preferably 1,300 to 3,000 mPa·s, more preferably 1,500 to 3,000 mPa·s, further preferably 1,700 to 3,000 mPa·s. When the viscosity at 20° C. of the composition is within the above range, the composition not only is excellent in handleability when used in various applications, but also can exert a high thickening effect in various formulations. In particular, in the case of use of the composition of the present invention in an application described below; when the viscosity of the composition is within the above range, the composition of the present invention is easily mixed with, dissolved in, or dispersed in a composition composed of various components. An advantage which can be achieved is that a composition, for example, causing hardly dripping and having excellent handleability, or having a favorable appearance due to an adequate viscosity is obtained by a high thickening effect due to the composition of the present invention, after mixing.

The composition of the present invention can be prepared by, for example, adding the vinyl alcohol-based polymer (A) in a solid state, to a solution comprising the surfactant (B) and water, and mixing and stirring the resultant. In the present invention, the vinyl alcohol-based polymer (A) can be loaded in a solid state to water comprising the surfactant (B) without being prepared into a solution soluble in water in advance, and therefore is easily handled and easily controlled to the desired concentration. In addition, an advantage is that an operation process can be simplified and thus the desired composition can be efficiently prepared.

Accordingly, the present invention is also directed to
a method for producing the composition of the present invention, the method including adding the vinyl alcohol-based polymer (A) in a solid state, to a solution comprising the surfactant (B) and water. The form of the vinyl alcohol-based polymer (A) in a solid state, loaded to water comprising the surfactant (B), is not particularly limited, and may be a powder, a granule, or a paste.

Conditions in mixing of the vinyl alcohol-based polymer (A) in a solid state with water comprising the surfactant (B) in the production method of the present invention are not particularly limited. For example, the mixing temperature may be 0 to 50° C., and is preferably 10 to 40° C.

In a case where the composition of the present invention includes other component than the vinyl alcohol-based polymer (A), the surfactant (B) and water, such other component may be mixed with water together with the surfactant (B) in advance. Alternatively, such other component may be loaded together with the vinyl alcohol-based polymer (A) into a solution comprising the surfactant (B) and water, or may be mixed with a solution after dissolution of the vinyl alcohol-based polymer (A).

One embodiment of the composition of the present invention relates to various compositions except for any composition encompassed in household detergent products. Herein, household detergent products include a detergent for dishes, a detergent for dishwashers, a laundry detergent for cloths, a hard surface detergent, a bleacher, a softener, a residential detergent or any mixture thereof.

One embodiment of the composition of the present invention relates to a composition selected from the group consisting of a composition for agricultural products, a composition for automobile products, a composition for aviation products, a composition for industrial products, a composition for livestock products, a marine product composition, a pharmaceutical composition, a composition for personal care products, a composition for recreation products, and a water treatment agent composition.

Agricultural products mean products and materials used in agriculture and horticulture. Examples of the composition for agricultural products typically include an agrochemical composition, and examples include an insecticide, a fungicide, an insecticide-fungicide combination, an herbicide, a rodenticide, a plant growth regulator, an attractant, a spreading agent, a rejectant, a defoliant, a fertilizer, and trace element/micronutrient.

In a case where the composition of the present invention is an agrochemical composition, the composition can include, in addition to the vinyl alcohol-based polymer (A), the surfactant (B) and water, for example, an effective component for imparting desired action and function such as an insecticidal or weeding action.

Automobile products mean products and materials used in the automobile industry. Examples of the composition for automobile products include a cleaner for car washing, and a window washer liquid.

Aviation products mean products and materials used in the airline industry. Examples of the composition for aviation products include an aircraft cleaner.

Industrial products mean products and materials used in the manufacturing industry. Examples of the composition for industrial products include a machine cleaner.

Livestock products mean products and materials used in dairy and livestock. Examples of the composition for livestock products include a cattle house cleaner, and a farm equipment cleaner.

Marine products mean products and materials used in the fishing industry, the fisheries industry, the shipbuilding industry, sea search, and the like. Examples of the marine product composition include a marine vessel cleaner, a marine equipment cleaner, and a fishery processing equipment cleaner.

The pharmaceutical composition includes a pharmaceutical product and a nonmedicinal product.

Personal care products mean products applicable to the human body or the body of animals other than humans. The “body” as mentioned herein includes the skin, teeth, nails, and hair. Examples of personal care products include a cosmetic product, a shampoo, body soap, a face-washing preparation, and a toothpaste.

Recreation products mean products and materials used in recreation. Examples of the composition for recreation products include a foam spraying agent, a bath additive, and a foaming agent for pool.

The water treatment agent means an agent added to and used in water or a liquid mainly comprising water (comprising 50% by mass or more of water based on the total mass) for the purpose of preventing the occurrence of microorganisms, corrosion prevention, scale prevention, and/or the like. Examples of the water treatment agent composition include a water treatment agent for water supply, an industrial water treatment agent, a wastewater treatment agent, an industrial wastewater treatment agent, and a pool water clarifier.

In a case where the composition of the present invention is a water treatment agent composition, the composition can include, in addition to the vinyl alcohol-based polymer (A), the surfactant (B) and water, for example, a polymer coagulant constituted from a water-soluble (co) polymer with a water-soluble monomer as a constituent unit, or an inorganic coagulant.

The vinyl alcohol-based polymer (A) is excellent in solubility in water comprising a surfactant, and therefore the composition of the present invention, including the vinyl alcohol-based polymer, not only realizes a high transparency, but also has a viscosity easily controlled in the range which depends on the application of the composition. Accordingly, the present invention is also directed to a vinyl alcohol- based polymer (A) including: a monomer unit having an alkyl group: wherein the vinyl alcohol-based polymer (A) satisfies the following formula (1):

0.010 ≤X/(S×N)≤0.040 (1)

wherein S is the content (parts by mass) of the monomer unit having an alkyl group based on 100 parts by mass of the total monomer unit in the vinyl alcohol-based polymer (A), X is the degree (% by mol) of saponification of the vinyl alcohol-based polymer (A), and N is the viscosity-average degree of polymerization of the vinyl alcohol-based polymer (A).

The present invention is also directed to a resin material including a-olefin, sodium acetate, and the vinyl alcohol-based polymer (A) of the present invention, wherein the content of the a-olefin is 0.05% by mass or more, and the content of the sodium acetate is 1.0% by mass or less based on the total mass of the resin material.

In one preferred embodiment of the present invention, the vinyl alcohol-based polymer (A) is included as a resin material comprising α-olefin and sodium acetate, in the composition of the present invention. The content of the α-olefin in the resin material is preferably 0.05% by mass or more, more preferably 0.08% by mass or more, further preferably 0.11% by mass or more, based on the total mass of the resin material. The content of the α-olefin is preferably 1.0% by mass or less. The content of the α-olefin is in the above range, whereby, when the resin material is formed into an aqueous solution, the monomer unit having an alkyl group easily allows the alkyl group to intermolecularly interaction and the thickening effect of the aqueous solution is easily increased. One, or two or more of such α-olefins may be contained in the resin material. In a case where the resin material contains two or more of such α-olefins, the content of the α-olefin means the total amount of such a plurality of α-olefins contained in the resin material.

The α-olefin contained in the resin material is preferably an α-olefin having 6 to 18 carbon atoms. The α-olefin is preferably, for example, 1-hexene, 1-heptene, 1-octene, 1-nonene, 1-decene, 1-dodecene, 1-tridecene, 1-tetradecene, 1-pentadecene, 1-hexadecene, 1-octadecene, and more preferably includes at least one selected from the group consisting of 1-dodecene and 1-hexadecene. The α-olefin contained in the resin material may be the same as or different from that in the above alkyl group-containing monomer. The α-olefin contained in the resin material may be derived from the α-olefin used as the alkyl group-containing monomer in production of the polyvinyl alcohol-based polymer (A), or may be added separately from the polyvinyl alcohol-based polymer (A).

The content of the sodium acetate in the resin material is preferably 2.0% by mass or less, more preferably 1.0% by mass or less, further preferably 0.9% by mass or less, still further preferably 0.85% by mass or less based on the total mass of the resin material. The content of the sodium acetate is in the above range, whereby, when the resin material is formed into an aqueous solution, a molecule backbone of the vinyl alcohol polymer (A) is sufficiently easily spread in the solution, and a high thickening effect can be expected.

The resin material in the present invention may contain a component other than the vinyl alcohol-based polymer (A), α-olefin and sodium acetate, and in one preferred embodiment of the present invention, the resin material is substantially composed of the vinyl alcohol-based polymer (A), α-olefin and sodium acetate. Herein, the “substantially” means that a component is not excluded which can be unavoidably incorporated due to, for example, raw materials used in the course of production of the polyvinyl alcohol-based polymer (A) or the resin material. In one preferred embodiment of the present invention, the content of other component than the vinyl alcohol-based polymer (A), α-olefin and sodium acetate, contained in the resin material, is usually 5% by mass or less, preferably 3% by mass or less based on the total mass of the resin material.

One preferred embodiment of the composition of the present invention relates to a composition including the above resin material. In other words, this composition includes the vinyl alcohol-based polymer (A), α-olefin, sodium acetate, the surfactant (B), and the water (C). The content of the resin material in the composition can be appropriately determined depending on the structure (type) of the vinyl alcohol-based polymer (A) contained in the resin material, the intended application of the composition, the desired viscosity, and the like. In one embodiment of the present invention, the content of the resin material is preferably 0.1 to 5.0% by mass, more preferably 0.5 to 5.0% by mass, further preferably 0.5 to 4.0% by mass based on the total mass of the composition.

### EXAMPLES

Hereinafter, the present invention is described in more detail with reference to Examples, but the present invention is not limited by the following Examples. In the Examples, “%” and “parts” respectively mean % by mass and parts by mass, unless particularly noted.

Hereinafter, the resin material including the vinyl alcohol-based polymer (A), obtained in each of Examples and Comparative Examples, was used, and the degree (X) of saponification, the viscosity-average degree (N) of polymerization and the amount(S) of the alkyl group-containing monomer unit of the vinyl alcohol-based polymer (A) in the resin material were measured/calculated according to the following methods. Hereinafter, the “vinyl alcohol-based polymer” is sometimes abbreviated as “PVA”.
(i) Degree (X) of saponification of PVA (A)

The degree (X) of saponification of PVA (A) was measured according to JIS K6726:1994.
(ii) Viscosity-average degree (N) of polymerization of PVA (A)

The viscosity-average degree (N) of polymerization of PVA (A) was measured according to JIS K6726:1994. Specifically, in a case where the degree of saponification of PVA (A) was less than 99.5% by mol, the viscosity-average degree of polymerization was determined according to the following formula with the limiting viscosity [η] (L/g) of PVA (A) obtained by saponification until the degree of saponification reached 99.5% by mol or more, as measured at 30° C. in water.

Viscosity-average degree of polymerization=([η]×10⁴/8.29)⁽1/0.62)
(iii) Amount(S) of alkyl group-containing monomer unit of PVA (A)

The amount(S) of the alkyl group-containing monomer unit of PVA (A) was determined by calculating the proportion (% by mol) of the alkyl group-containing monomer unit relative to the total constituent unit of PVA (A) with 1H NMR, and converting the calculated proportion into the proportion (parts by mass) from the molecular weight of each constituent unit.
(iv) Content (% by mass) of α-olefin in resin material

The content (% by mass) of α-olefin in the resin material was measured with head space gas chromatography.

(v) Content of sodium acetate of resin material

The content (% by mass) of sodium acetate in the resin material was measured by a titration method based on JIS-K6726.

### Example 1

### 1. Production of Resin Material Including Vinyl Alcohol-Based Polymer (A)

A reactor equipped with a stirrer, a reflux cooling tube, a nitrogen introduction tube, and an addition port of a polymerization initiator was loaded with 900 parts by mass of vinyl acetate, 900 parts by mass of methanol and 40.0 parts by mass of 1-dodecene, and the system was subjected to replacement with nitrogen under bubbling with nitrogen for 30 minutes. Once the temperature of the reactor was initiated to be raised and the inner temperature reached 60°° C., 4.2 parts by mass of 2,2′-azobisisobutyronitrile (AIBN) as the polymerization initiator was added to initiate polymerization. After polymerization at 60°° C. for 4 hours, the polymerization was stopped by cooling. After the polymerization was stopped, the solid content concentration was 31.3% by mass, and the rate of polymerization was 60%. Subsequently, while methanol was added at intervals under reduced pressure at 30°° C., the unreacted monomer was removed to provide a solution (concentration 49.2% by mass) of a vinyl ester-based polymer in methanol. Next, a saponification reaction was conducted with sodium hydroxide at a concentration of the vinyl ester-based polymer, of 30%, a temperature of 40° C., a water content in a saponification reaction liquid, of 1%, and a molar ratio of a saponification catalyst to the vinyl ester-based polymer, of 0.0085, in the methanol solution. After a sodium hydroxide solution in methanol was added, a gel-like product was generated at about 15 minutes and thus was crushed by a crusher and furthermore left to still stand at 40° C. for 45 minutes to progress saponification. Thereafter, methyl acetate and methanol were added and left to still stand at 40° C. for 30 minutes, and the resultant was washed. A white solid obtained by repeating such a washing operation twice and then removing a liquid was dried in vacuum at 40°° C. for 16 hours, to provide a resin material (PVA-1) comprising PVA. PVA-1 was a resin material comprising the vinyl alcohol-based polymer (A), α-olefin and sodium acetate. The content of α-olefin and the content of sodium acetate in PVA-1 obtained, and the degree (X) of saponification, the viscosity-average degree (N) of polymerization and the amount(S) of the alkyl group-containing monomer unit of the vinyl alcohol-based polymer (A) in PVA-1 were measured/calculated. The results are shown in Table 2.

The content of the α-olefin-derived monomer unit based on the total amount of the monomer unit having an alkyl group in the vinyl alcohol-based polymer (A) was 100% by mass. The same also applied to Examples 2 to 13 and Comparative Examples 1 to 5 described below.

### 2. Preparation of Composition

A composition was obtained by adding 2 parts by mass of PVA-1 as the resin material comprising the vinyl alcohol-based polymer (A), and 20 parts by mass of sodium laureth sulfate (Na laureth sulfate) as the surfactant (B), to 78 parts by mass of water, and stirring them. The ratio of each component contained in the composition, and the type of the surfactant (B) were summarized in Table 2. Here, the contents of a-olefin and sodium acetate in the resin material were trace amounts, and thus the ratio of the resin material and the ratio of the vinyl alcohol-based polymer (A) in each of the compositions were substantially the same.

### [Examples 2 to 4, 6 and 8], [Comparative Examples 2 and 4 to 9]

### 1. Production of Resin Material Comprising Vinyl Alcohol-Based Polymer (A)

A vinyl ester-based copolymer was prepared, and a saponification reaction was conducted by the same procedure as in Example 1 except that polymerization conditions, such as the amounts of vinyl acetate and methanol loaded, and the type or the amount of a-olefin used in polymerization, and the molar ratio of sodium hydroxide to the vinyl acetate unit during saponification were changed according to Table 1. No gel-like products were generated in these Examples and Comparative Examples, and therefore methyl acetate and water were added after the saponification reaction was conducted for 1 hour, and then the resultant was dried in vacuum at 40° C. for 16 hours, to provide a resin material comprising each vinyl alcohol-based polymer (A) (PVA-2 to 4, 6, 8, 14, and 16 to 21).

### 2. Preparation of Composition

Each composition was obtained in the same manner as in Example 1 except that the type of the resin material comprising the vinyl alcohol-based polymer (A), and the type and the amount of the surfactant (B) were changed as described in Table 2.

### [Examples 5, 7, and 9 to 12], [Comparative Examples 1 and 3]

### 1. Production of Resin Material Comprising Vinyl Alcohol-based Polymer (A)

A resin material comprising each vinyl alcohol-based polymer (A) (PVA-5, 7, 9 to 12, 13, and 15) was produced by the same procedure as in Example 1 except that polymerization conditions, such as the amounts of vinyl acetate and methanol loaded, and the type or the amount of α-olefin used in polymerization, and the molar ratio of sodium hydroxide to the vinyl acetate unit during saponification were changed according to Table 1.

### 2. Preparation of Composition

A composition was obtained in the same manner as in Example 1 except that the type of the resin material comprising the vinyl alcohol-based polymer (A), and the type and the amount of the surfactant (B) were changed as described in Table 2.

### Example 13

A composition was obtained in the same manner as in Example 3 except that the amount of the surfactant (B) was changed as described in Table 2.

### Reference Example 1

A composition was obtained in the same manner as in Example 1 except that the resin material comprising the vinyl alcohol-based polymer (A) was not used. The composition corresponded to a viscosity-reference composition for calculation of the relative viscosity of each composition.

### Measurement and Evaluation of Physical Properties

### (1) Measurement of Viscosity of Composition

(i) Viscosity of composition (measured value)

The viscosity of each composition obtained in Examples, Comparative Examples, and Reference Example was measured at 60 rpm and 20° C. with a B-type viscometer (spindles LV-03 and LV-04). The results of measurement are shown in Table 3.
(ii) Relative viscosity

The relative viscosity of the composition of each of Examples and Comparative Examples was calculated according to the following formula with the composition of Reference Example 1 as the viscosity-reference composition. The results are shown in Table 3.

Relative viscosity=Viscosity (20° C.) of each composition of Examples or Comparative Examples/Viscosity (20° C.) of composition of Reference Example 1

While all of PVA-13 to 21 used in respective Comparative Examples did not correspond to the polyvinyl alcohol-based polymer (A) according to the present invention, the relative viscosities in Comparative Examples 1 to 9 were respectively calculated for comparison with formulations obtained by excluding PVA-13 to 21 from the formulations in Comparative Examples.

It means that, as the numerical value of the relative viscosity is larger, the thickening effect is more excellent.

### (2) Transparency

Immediately after each composition was prepared in Examples and Comparative Examples, the haze of such each composition was measured with a haze meter (HZ-1 manufactured by Suga Test Instruments Co., Ltd.) using a cell having an optical path length of 1 cm. One exhibiting a measurement value of 5% or less was rated as “Transparent”, and one exhibiting a measurement value of more than 5% was rated as “Opaque”. The results are shown in Table 3.

### (3) Solution Stability

Immediately after each composition was prepared in Examples and Comparative Examples, and after 44 days from the preparation of each composition, the haze of each composition was measured with a haze meter (HZ-1 manufactured by Suga Test Instruments Co., Ltd.) using a cell having an optical path length of 1 cm, and was evaluated according to the following criteria. The results are shown in Table 3.
A: a haze of 5% or less immediately after composition preparation and after 44 days from the preparation
B: a haze of 5% or less immediately after composition preparation, but a haze of more than 5% after 44 days from the preparation
C: a haze of more than 5% immediately after composition preparation

TABLE 1

| | | | | | | | | Saponification |
|---|---|---|---|---|---|---|---|---|
| | | | | | | | | step |
| | | Polymerization step | | | | | | Amount (molar |
| | | | | Type of α-olefin | | | | ratio) of |
| | | Vinyl | | | Initial | Polymerization | Rate of | catalyst |
| | Resin | acetate | Methanol | | loading | initiator | polymerization | relative to |
| | material | (parts) | (parts) | Type | (parts) | (wt %/VAc) | (%) | PVAc |
| Example 1 | PVA-1 | 900 | 900 | 1-Dodecene | 40 | 0.27 | 60 | 0.0085 |
| Example 2 | PVA-2 | 900 | 900 | 1-Dodecene | 40 | 0.27 | 60 | 0.0050 |
| Example 3 | PVA-3 | 900 | 900 | 1-Dodecene | 40 | 0.27 | 60 | 0.0050 |
| Example 4 | PVA-4 | 900 | 900 | 1-Hexadecene | 50 | 0.29 | 60 | 0.0048 |
| Example 5 | PVA-5 | 900 | 900 | 1-Dodecene | 50 | 0.29 | 60 | 0.0073 |
| Example 6 | PVA-6 | 900 | 900 | 1-Dodecene | 50 | 0.29 | 60 | 0.0039 |
| Example 7 | PVA-7 | 1080 | 720 | 1-Dodecene | 48 | 0.20 | 50 | 0.0071 |
| Example 8 | PVA-8 | 1080 | 720 | 1-Dodecene | 48 | 0.20 | 50 | 0.0044 |
| Example 9 | PVA-9 | 1080 | 720 | 1-Dodecene | 122 | 0.33 | 50 | 0.0095 |
| Example 10 | PVA-10 | 1260 | 540 | 1-Dodecene | 60 | 0.26 | 40 | 0.0067 |
| Example 11 | PVA-11 | 900 | 900 | 1-Dodecene | 40 | 0.27 | 60 | 0.0073 |
| Example 12 | PVA-12 | 1260 | 540 | 1-Dodecene | 60 | 0.26 | 40 | 0.0070 |
| Comparative | PVA-13 | 900 | 900 | 1-Dodecene | 30 | 0.27 | 60 | 0.0075 |
| Example 1 | | | | | | | | |
| Comparative | PVA-14 | 900 | 900 | 1-Dodecene | 115 | 0.32 | 60 | 0.0070 |
| Example 2 | | | | | | | | |
| Comparative | PVA-15 | 1080 | 720 | 1-Dodecene | 40 | 0.20 | 50 | 0.0110 |
| Example 3 | | | | | | | | |
| Comparative | PVA-16 | 1080 | 720 | 1-Dodecene | 120 | 0.32 | 50 | 0.0075 |
| Example 4 | | | | | | | | |
| Comparative | PVA-17 | 1260 | 540 | 1-Dodecene | 75 | 0.26 | 40 | 0.0042 |
| Example 5 | | | | | | | | |
| Comparative | PVA-18 | 900 | 900 | 1-Dodecene | 0 | 0.16 | 60 | 0.0028 |
| Example 6 | | | | | | | | |
| Comparative | PVA-19 | 1080 | 720 | 1-Dodecene | 0 | 0.14 | 50 | 0.0026 |
| Example 7 | | | | | | | | |
| Comparative | PVA-20 | 1170 | 630 | 1-Dodecene | 0 | 0.11 | 40 | 0.0023 |
| Example 8 | | | | | | | | |
| Comparative | PVA-21 | 360 | 1440 | 1-Dodecene | 0 | 0.32 | 60 | 0.0033 |
| Example 9 | | | | | | | | |

TABLE 2

| | Resin material | | | | | | | |
|---|---|---|---|---|---|---|---|---|
| | | Vinyl alcohol polymer (A) | | | | | | |
| | | | | | Amount S of | | | Content |
| | | | | | alkyl group- | | Content | of |
| | | Average- | | | containing | | of α- | sodium |
| | | viscosity | | | monomer unit | | olefin | acetate |
| | | degree N of | Degree X of | Type of α- | (parts by | Value of | (% by | (% by |
| | No. | polymerization | saponification | olefin | mass) | formula (1) | mass) | mass) |
| Example 1 | PVA-1 | 500 | 70.0 | 1-Dodecene | 3.7 | 0.038 | 0.11 | 0.95 |
| Example 2 | PVA-2 | 537 | 38.6 | 1-Dodecene | 3.0 | 0.024 | 0.13 | 0.80 |
| Example 3 | PVA-3 | 537 | 38.6 | 1-Dodecene | 3.0 | 0.024 | 0.13 | 0.80 |
| Example 4 | PVA-4 | 522 | 40.1 | 1-Hexadecene | 5.0 | 0.015 | 0.15 | 0.80 |
| Example 5 | PVA-5 | 480 | 75.0 | 1-Dodecene | 4.8 | 0.033 | 0.12 | 0.95 |
| Example 6 | PVA-6 | 480 | 42.1 | 1-Dodecene | 3.9 | 0.022 | 0.15 | 0.80 |
| Example 7 | PVA-7 | 800 | 70.2 | 1-Dodecene | 3.5 | 0.025 | 0.12 | 0.95 |
| Example 8 | PVA-8 | 800 | 40.9 | 1-Dodecene | 3.8 | 0.013 | 0.16 | 0.80 |
| Example 9 | PVA-9 | 800 | 70.3 | 1-Dodecene | 8.6 | 0.010 | 0.22 | 0.95 |
| Example 10 | PVA-10 | 1700 | 71.9 | 1-Dodecene | 3.6 | 0.012 | 0.13 | 0.95 |
| Example 11 | PVA-11 | 537 | 39.5 | 1-Dodecene | 3.0 | 0.025 | 0.15 | 1.30 |
| Example 12 | PVA-12 | 1700 | 71.9 | 1-Dodecene | 3.6 | 0.012 | 0.04 | 0.30 |
| Example 13 | PVA-3 | 537 | 38.6 | 1-Dodecene | 3.0 | 0.024 | 0.13 | 0.80 |
| Comparative | PVA-13 | 500 | 70.4 | 1-Dodecene | 2.4 | 0.059 | 0.06 | 0.95 |
| Example 1 | | | | | | | | |
| Comparative | PVA-14 | 550 | 40.4 | 1-Dodecene | 9.3 | 0.008 | 0.40 | 1.30 |
| Example 2 | | | | | | | | |
| Comparative | PVA-15 | 800 | 82.3 | 1-Dodecene | 2.5 | 0.041 | 0.07 | 1.30 |
| Example 3 | | | | | | | | |
| Comparative | PVA-16 | 800 | 40.2 | 1-Dodecene | 9.3 | 0.005 | 0.40 | 0.80 |
| Example 4 | | | | | | | | |
| Comparative | PVA-17 | 1700 | 47.5 | 1-Dodecene | 4.0 | 0.007 | 0.18 | 0.80 |
| Example 5 | | | | | | | | |
| Comparative | PVA-18 | 489 | 45.9 | — | 0 | — | 0.00 | 0.80 |
| Example 6 | | | | | | | | |
| Comparative | PVA-19 | 854 | 43.8 | — | 0 | — | 0.00 | 0.80 |
| Example 7 | | | | | | | | |
| Comparative | PVA-20 | 1029 | 38.5 | — | 0 | — | 0.00 | 0.80 |
| Example 8 | | | | | | | | |
| Comparative | PVA-21 | 200 | 48.1 | — | 0 | — | 0.00 | 0.80 |
| Example 9 | | | | | | | | |
| Reference | — | — | — | — | — | — | — | — |
| Example 1 | | | | | | | | |

| | Composition | | | | | | | | |
|---|---|---|---|---|---|---|---|---|---|
| | Ratio of resin material | | Ratio of PVA (A) | | Ratio of (B) | | Type of | (A)/(B) | Water |
| | (parts by | (% by | (parts by | (% by | (parts by | (% by | surfactant | (mass | (parts by |
| | mass) | mass) | mass) | mass) | mass) | mass) | (B) | ratio) | mass) |
| Example 1 | 2.0 | 2.0 | 2.0 | 2.0 | 20 | 20.0 | Na laureth | 0.10 | 78 |
| | | | | | | | sulfate | | |
| Example 2 | 2.0 | 2.0 | 2.0 | 2.0 | 20 | 20.0 | Na laureth | 0.10 | 78 |
| | | | | | | | sulfate | | |
| Example 3 | 2.0 | 1.5 | 2.0 | 1.5 | 50 | 38.5 | Na laureth | 0.05 | 78 |
| | | | | | | | sulfate | | |
| Example 4 | 2.0 | 2.0 | 2.0 | 2.0 | 20 | 20.0 | Na laureth | 0.10 | 78 |
| | | | | | | | sulfate | | |
| Example 5 | 2.0 | 2.0 | 2.0 | 2.0 | 20 | 20.0 | Na laureth | 0.10 | 78 |
| | | | | | | | sulfate | | |
| Example 6 | 2.0 | 2.0 | 2.0 | 2.0 | 20 | 20.0 | Na laureth | 0.10 | 78 |
| | | | | | | | sulfate | | |
| Example 7 | 2.0 | 2.0 | 2.0 | 2.0 | 20 | 20.0 | Na laureth | 0.10 | 78 |
| | | | | | | | sulfate | | |
| Example 8 | 2.0 | 2.0 | 2.0 | 2.0 | 20 | 20.0 | Na laureth | 0.10 | 78 |
| | | | | | | | sulfate | | |
| Example 9 | 2.0 | 2.0 | 2.0 | 2.0 | 20 | 20.0 | Na laureth | 0.10 | 78 |
| | | | | | | | sulfate | | |
| Example 10 | 2.0 | 2.0 | 2.0 | 2.0 | 20 | 20.0 | Na laureth | 0.10 | 78 |
| | | | | | | | sulfate | | |
| Example 11 | 2.0 | 2.0 | 2.0 | 2.0 | 20 | 20.0 | Na laureth | 0.10 | 78 |
| | | | | | | | sulfate | | |
| Example 12 | 2.0 | 2.0 | 2.0 | 2.0 | 20 | 20.0 | Na laureth | 0.10 | 78 |
| | | | | | | | sulfate | | |
| Example 13 | 2.0 | 2.0 | 2.0 | 2.0 | 20 | 20.0 | Na lauryl | 0.10 | 78 |
| | | | | | | | sulfate | | |
| Comparative | 2.0 | 2.0 | 2.0 | 2.0 | 20 | 20.0 | Na laureth | 0.10 | 78 |
| Example 1 | | | | | | | sulfate | | |
| Comparative | 2.0 | 2.0 | 2.0 | 2.0 | 20 | 20.0 | Na laureth | 0.10 | 78 |
| Example 2 | | | | | | | sulfate | | |
| Comparative | 2.0 | 2.0 | 2.0 | 2.0 | 20 | 20.0 | Na laureth | 0.10 | 78 |
| Example 3 | | | | | | | sulfate | | |
| Comparative | 2.0 | 2.0 | 2.0 | 2.0 | 20 | 20.0 | Na laureth | 0.10 | 78 |
| Example 4 | | | | | | | sulfate | | |
| Comparative | 2.0 | 2.0 | 2.0 | 2.0 | 20 | 20.0 | Na laureth | 0.10 | 78 |
| Example 5 | | | | | | | sulfate | | |
| Comparative | 2.0 | 2.0 | 2.0 | 2.0 | 20 | 20.0 | Na laureth | 0.10 | 78 |
| Example 6 | | | | | | | sulfate | | |
| Comparative | 2.0 | 2.0 | 2.0 | 2.0 | 20 | 20.0 | Na laureth | 0.10 | 78 |
| Example 7 | | | | | | | sulfate | | |
| Comparative | 2.0 | 2.0 | 2.0 | 2.0 | 20 | 20.0 | Na laureth | 0.10 | 78 |
| Example 8 | | | | | | | sulfate | | |
| Comparative | 2.0 | 2.0 | 2.0 | 2.0 | 20 | 20.0 | Na laureth | 0.10 | 78 |
| Example 9 | | | | | | | sulfate | | |
| Reference | 0.0 | 0.0 | 0.0 | 0.0 | 20 | 20.4 | Na laureth | 0.00 | 78 |
| Example 1 | | | | | | | sulfate | | |

TABLE 3

| | Physical properties/Evaluation | | | |
|---|---|---|---|---|
| | of composition | | | |
| | Viscosity | | | |
| | (20° C.) | Relative | Trans- | Solution |
| | (mPa · s) | viscosity | parency | stability |
| Example 1 | 1820 | 1.82 | Transparent | B |
| Example 2 | 1900 | 1.90 | Transparent | A |
| Example 3 | 2680 | 2.68 | Transparent | A |
| Example 4 | 2730 | 2.73 | Transparent | A |
| Example 5 | 2030 | 2.03 | Transparent | B |
| Example 6 | 1730 | 1.73 | Transparent | A |
| Example 7 | 2300 | 2.30 | Transparent | B |
| Example 8 | 1950 | 1.95 | Transparent | A |
| Example 9 | 2650 | 2.65 | Transparent | B |
| Example 10 | 2520 | 2.52 | Transparent | B |
| Example 11 | 1790 | 1.79 | Transparent | A |
| Example 12 | 2390 | 2.39 | Transparent | B |
| Example 13 | 2620 | 2.62 | Transparent | A |
| Comparative Example 1 | 950 | 0.95 | Transparent | B |
| Comparative Example 2 | 2780 | 2.78 | Opaque | C |
| Comparative Example 3 | 960 | 0.96 | Transparent | C |
| Comparative Example 4 | 3200 | 3.20 | Opaque | C |
| Comparative Example 5 | 2920 | 2.92 | Opaque | C |
| Comparative Example 6 | 1060 | 1.06 | Transparent | A |
| Comparative Example 7 | 1270 | 1.27 | Transparent | A |
| Comparative Example 8 | 1580 | 1.58 | Transparent | A |
| Comparative Example 9 | 760 | 0.76 | Transparent | A |
| Reference Example 1 | 1000 | — | Transparent | A |

Each composition (Examples 1 to 13) according to the present invention exerted a high thickening effect and was also excellent in transparency.

1. A composition (provided that a composition for household detergent products is excluded) comprising:
(A) the vinyl alcohol-based polymer of claim 18;
(B) at least one surfactant; and
(C) water,

2. The composition according to claim 1, wherein the vinyl alcohol-based polymer (A) comprises a monomer unit having an alkyl group having 4 to 16 carbon atoms.

3. The composition according to claim 1, wherein the monomer unit having an alkyl group comprises an α-olefin-derived monomer unit.

4. The composition according to claim 1, wherein the monomer unit having an alkyl group comprises an α-olefin-derived monomer unit, and the content of the α-olefin-derived monomer unit having an alkyl group based on the total amount of the monomer unit having an alkyl group is 60% by mass or more.

5. The composition according to claim 1, wherein the content S of the monomer unit having an alkyl group based on 100 parts by mass of the total monomer unit in the vinyl alcohol-based polymer (A) is 1.2 to 9.0 parts by mass.

6. The composition according to claim 1, wherein the degree X of saponification of the vinyl alcohol-based polymer (A) is 40 to 80% by mol.

7. The composition according to claim 1, wherein the viscosity-average degree N of polymerization of the vinyl alcohol-based polymer (A) is 400 to 2000.

8. The composition according to claim 1, wherein the mass ratio (A/B) between the vinyl alcohol-based polymer (A) and the surfactant (B) is 1/99 to 99/1.

9. The composition according to claim 1, wherein the surfactant (B) comprises an anionic surfactant.

10. The composition according to claim 1, wherein the surfactant (B) comprises at least one selected from the group consisting of alkyl sulfate, alkyl sulfonate, alkylbenzene sulfonate, polyoxyalkylene alkyl ether sulfate (alkyl ether sulfate), polyoxyalkylene alkyl ether carboxylate (alkyl ether acetate), α-olefin sulfonate, a phosphoric ester salt, an acylamino acid salt, acyl taurate, acyl lactate, soap (higher fatty acid), alkyl sulfosuccinate, an acyl hydrolyzed collagen salt and acyl isethionate.

11. The composition according to claim 1, wherein the content of the vinyl alcohol-based polymer (A) is 0.1 to 5.0% by mass based on the total mass of the composition.

12. The composition according to claim 1, wherein the content of the surfactant (B) is 1 to 50% by mass based on the total mass of the composition.

13. The composition according to claim 1, wherein the relative viscosity of the composition, as calculated according to the following, is 1.60 to 3.10:
Relative viscosity of composition=Viscosity at 20° C. of composition/Viscosity at 20° C. of viscosity-reference composition having formulation excluding vinyl alcohol-based polymer (A) from composition as measurement object.

14. The composition according to claim 1, wherein the viscosity at 20° C. is 1,300 to 3,000 mPa·s.

15. A composition comprising:
(A) the vinyl alcohol-based polymer of claim 18;
(B) a surfactant; and
(C) water,
wherein the composition is a composition selected from the group consisting of a composition for agricultural products, a composition for automobile products, a composition for aviation products, a composition for industrial products, a composition for livestock products, a marine product composition, a pharmaceutical composition, a composition for personal care products, a composition for recreation products, and a water treatment agent composition.

16. The composition according to claim 15, wherein
the monomer unit having an alkyl group comprises an α-olefin-derived monomer unit, and
the content of the α-olefin-derived monomer unit having an alkyl group based on the total amount of the monomer unit having an alkyl group is 60% by mass or more.

17. A method for producing the composition according to claim 1, the method comprising adding the vinyl alcohol-based polymer (A) in a solid state, to a solution comprising the surfactant (B) and water.

18. A vinyl alcohol-based polymer (A) comprising a monomer unit having an alkyl group,
wherein the vinyl alcohol-based polymer (A) satisfies the following formula (1):
0.010≤X/(S×N)≤0.040 (1)
wherein S is the content (parts by mass) of the monomer unit having an alkyl group based on 100 parts by mass of the total monomer unit in the vinyl alcohol-based polymer (A), X is the degree (% by mol) of saponification of the vinyl alcohol-based polymer (A), and N is the viscosity-average degree of polymerization of the vinyl alcohol-based polymer (A).

19. The vinyl alcohol-based polymer (A) according to claim 18, wherein
the monomer unit having an alkyl group comprises an α-olefin-derived monomer unit, and
the content of the α-olefin-derived monomer unit having an alkyl group based on the total amount of the monomer unit having an alkyl group is 60% by mass or more.

20. A resin material comprising the vinyl alcohol-based polymer (A) according to claim 18, wherein
the resin material comprises an α-olefin and sodium acetate, and
the content of the α-olefin is 0.05% by mass or more and the content of the sodium acetate is 2.0% by mass or less, based on the total mass of the resin material.

21. The resin material according to claim 20, wherein the a-olefin comprises an α-olefin having 6 to 18 carbon atoms.

22. The resin material according to claim 20, wherein the α-olefin comprises at least one selected from the group consisting of 1-dodecene and 1-hexadecene.
